(19) United States
(12) Patent Application Publication
(10) Pub. No.: US 2002/0080760 A1
(43) Pub. Date: Jun. 27, 2002

(54) Radio-operated telecommunication system

(75) Inventors: Warich Anja, Stuttgart (DE); Mortensen Ivar, Stuttgart (DE)

Correspondence Address: SUGHRUE, MION, ZINN, MACPEAK & SEAS, PLLC, Pennsylvania Avenue, N.W., Washington, DC, 20037-3213, US

(73) Assignee: ALCATEL

(21) Appl. No.: 10/020,175

(22) Filed: Dec. 18, 2001

(30) Foreign Application Priority Data
Dec. 27, 2000 (DE) 100 65 238.7

(51) Int. Cl. H04L 12/43

(52) U.S. Cl. 370/341; 370/461

(57) ABSTRACT

A detector for a base station of a radio-operated telecommunication system is described. In the telecommunication system, a mobile unit can generate and transmit a signal which is provided as an access request by the mobile unit to the base station. In addition, in the telecommunication system, the signal can be received by the base station and the application request recognized. The signal received by the base station is based on a Hadamard transform. In addition, the detector is suitable for application of the Hadamard transform.

### BACKGROUND OF THE INVENTION

The invention concerns a method for the operation of a radio-operated telecommunication system, in which a mobile unit generates and transmits a signal which is provided as an access request by the mobile unit to a base station, and in which the signal is received by the base station and the access request is recognized. The invention also concerns a detector for a base station of a radio-operated telecommunication system, as well as the base station as such and the telecommunication system overall.

Such a telecommunication system can be, for example, a Universal Mobile Telecommunication System (UMTS). It is known, in that case, that a mobile unit requesting user access from a base station transmits a so-called Random Access Channel Signal (RACH). The signal is received and then processed by the base station. In particular, the base station recognizes on the basis of the signal that a mobile unit located within the range of the base station wishes to transmit and is therefore requesting user access from the base station.

Known in the art, for the purpose of recognizing the access request by the mobile unit, is the practice of applying a so-called fast Fourier transform (FFT) to the received signal in the base station. This procedure, however, involves a large resource requirement within the base station.

### SUMMARY OF THE INVENTION

The object of the invention is to create a method for the operation of a radio-operated telecommunication system by means of which it is possible for the received signal to be processed within the base station with a lesser resource requirement.

This object is achieved by the method according to claim 1. The object is also achieved by the detector according to claim 8, the basis station according to claim 13 and the telecommunication system according to claim 14.

The invention is based on a priority application 100 65 328.7 which is hereby incorporated by reference.

The use of the Hadamard transform in the generation of the signal in the mobile unit, as well as in the processing of the signal in the base station, substantially reduces the resource requirement within the base station for the recognition of the access request. In particular, a fast Fourier transform is no longer required. Instead, it is sufficient for the signal received by the base station to be processed in the base station by means of the Hadamard transform. This does not require a large amount of resources, even if the Hadamard transform is applied directly to the received signal.

In the case of an advantageous design of the invention, in the generation of the signal by the mobile unit, a signature is generated on the basis of the Hadamard transform and multiply repeated. The base station then recognizes the signature from the received signal by means of the Hadamard transform and deduces the access request by the mobile unit. The use of the signature and the repetition of this signature substantially increases the probability that the signal transmitted by the mobile unit is recognized by the base station. Processing of the repetitions within the base station, however, requires only a small amount of resources.

In the case of a first embodiment of the invention, the Hadamard transform is first applied by the base station to each of the repetitions of the signature and the signature is then deduced from the results of the applications of the Hadamard transform. This ultimately represents a direct application of the Hadamard transform to the repetitions of the signature.

In the case of a second embodiment of the invention, the results of the applications of the Hadamard transform are combined in blocks and the signature is then deduced from the results of the blocks. This offers the advantage of better compensation of possible Doppler effects occurring during the transmission of the signal from the mobile unit to the base station. The block processing, likewise, requires only a small amount of resources.

In the case of a third embodiment of the invention, the repetitions of the signature are first linked to one another by the base station and the signature is then deduced from the linkages by means of the Hadamard transform. This embodiment offers the particular advantage, in comparison with the first embodiment, that the Hadamard transform has to be applied only once to the linkages of the repetitions. Consequently, only a single detector element is required in the base station for the application of the Hadamard transform to the linkages. This results in a substantial simplification of the base station.

In the case of a fourth embodiment of the invention, the linkages of the repetitions are combined in blocks and the signature is then deduced from the results of the blocks. This measure likewise affords better compensation of possibly occurring Doppler effects.

It is particularly advantageous if a scrambling code is used by the mobile unit in the generation of the signal and if the same scrambling code is used by the base station in the processing of the signal. In this way, it is possible to further increase the probability that the signal transmitted by the mobile unit is recognized by the base station.

### BRIEF DESCRIPTION OF THE DRAWINGS

Further features, application possibilities and advantages of the invention are disclosed by the following description of embodiment examples of the invention, which are represented in the figures. All described or represented features, either singly or in any combination, constitute the subject-matter of the invention, irrespective of their combination in the claims or their relatedness, and irrespective of their wording and representation in the description and drawing respectively.

FIG. 1 shows a schematic block diagram of an embodiment example of a telecommunication system according to the invention,

FIG. 2a shows a schematic block diagram of the basic structure of a detector element for a detector of the telecommunication system of FIG. 1,

FIG. 2b shows a schematic block diagram of the entire detector element,

FIG. 3 shows a schematic block diagram of a first embodiment example of the detector of the telecommunication system of FIG. 1,

FIG. 4 shows a schematic block diagram of a second embodiment example of the detector of the telecommunication system of FIG. 1,

FIG. 5 shows a schematic block diagram of a third embodiment example of the detector of the telecommunication system of FIG. 1, and

FIG. 6 shows a schematic block diagram of a fourth embodiment example of the detector of the telecommunication system of FIG. 1.

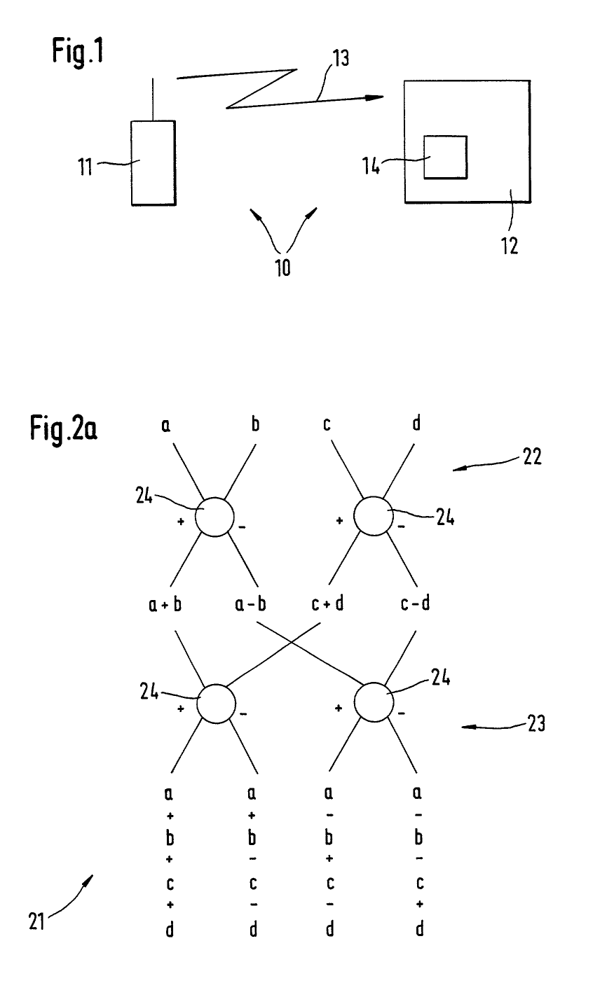

Represented in FIG. 1 is a radio-operated telecommunication system 10 which comprises a mobile unit 11 and a base station 12. The telecommunication system 10 is a so-called Universal Mobile Telecommunication System (UMTS). It is to be understood that there can also be further mobile units and/or base stations present in the telecommunication system 10.

When the mobile unit 11 of the telecommunication system 10 is switched on by a user, the mobile unit 11 generates and transmits a signal 13 by which the mobile unit 11 attempts to access the base station 12 as a user. This signal 13 is also termed a Random Access Channel Signal (RACH signal).

The signal 13 is generated by the mobile unit as follows:

A signature is first randomly selected by the mobile unit 11 from a number of permissible signatures. These permissible signatures are produced by means of a Hadamard transform, as to be explained below.

The signature has a length of 16 so-called chips. A chip is the unit of information that is transmitted per clock pulse unit in the telecommunication system 10 between the mobile unit 11 and the base station 12.

This signature is repeated 256 times, thus producing a data word having a length of 16×256=4096 chips. A scrambling code, which likewise has a length of 4096 chips, is then applied to the said data word. From this is produced the signal 13, which is then transmitted by the mobile unit 11 as a so-called BURST signal.

The Hadamard transform is an orthogonal transform. This means that, in the case of the signature having a length of 16 chips, rather than the use of 16² chip combination possibilities within the signature, as would be intrinsically possible, only 16 combination possibilities are used. The 16 signatures used are those whose cross correlation is equal to zero. There are thus only 16 different signatures which can be allocated to 16 different mobile units and on which the signal 13 can then be based.

The base station 12 comprises a detector 14 which is provided to process a signal 13 received by the base station 12. In particular, the detector 14 is provided to recognize the signature contained in the signal 13.

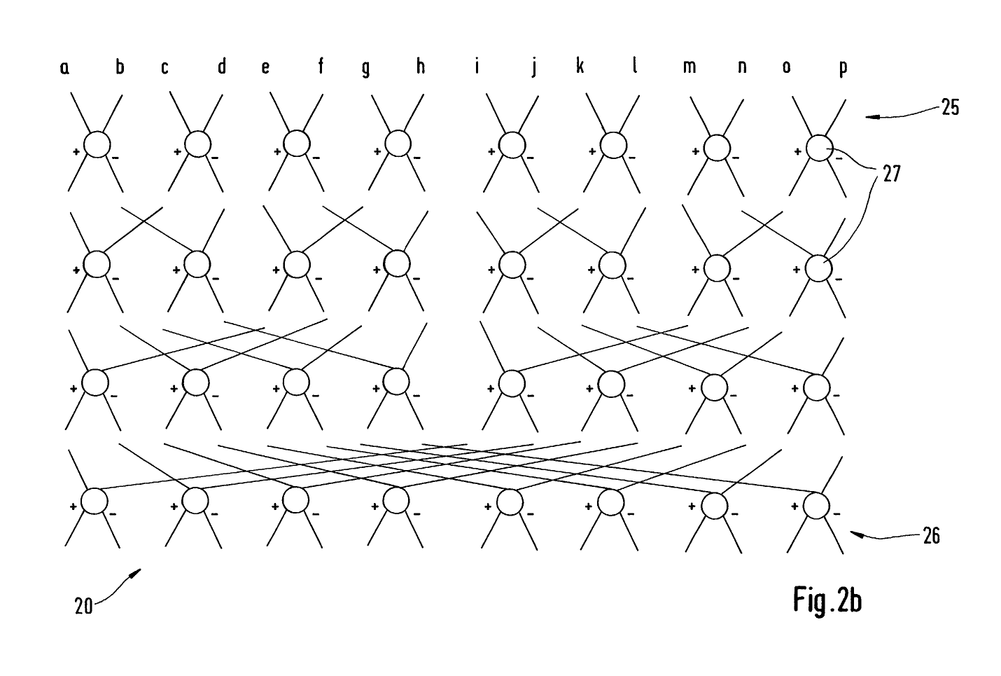

For this purpose, the detector 14 of the base station 12 comprises a plurality of detector elements 20, one of which is represented in FIG. 2b. To facilitate understanding of the detector element 20 of FIG. 2b, the basic structure 21 of the detector element 20 is shown in FIG. 2a.

The basic structure 21 of FIG. 2a relates to a signature which is based on the Hadamard transform but which has a length of only 4 chips. The basic structure 21 therefore also has only 4 inputs 22 and 4 outputs 23. The 4 chips applied to the inputs 22 are exemplarily denoted as a, b, c, d. In the basic structure 21, these chips are linked to one another by means of addition and subtraction stages 24 in such a way that the indicated combinations of the chips a, b, c, d are present at the outputs 23. This linkage of the chips represented in FIG. 2a corresponds to the inversion of the Hadamard transform, so that the combinations of the chips a, b, c, d present at the outputs 23 of the basic structure 21 are orthogonal relative to one another.

The detector element 20 of FIG. 2b is produced through a corresponding multiplication of the basic structure 21 of FIG. 2a. The detector element 20 relates to a signature which is again based on the Hadamard transform but which—as initially stated above—has a length of 16 chips. The detector element 20 thus has 16 inputs 25, 16 outputs 26 and a plurality of addition and subtraction stages 27.

It is thus possible, by means of the detector element 20 of FIG. 2b, to recognize an unknown signature which is based on the Hadamard transform and has a length of 16 chips. In the detector element 20, the recognized signature then results from the fact that the associated output 26 differs from the other outputs 26 of the detector element 20 in respect of its signal strength.

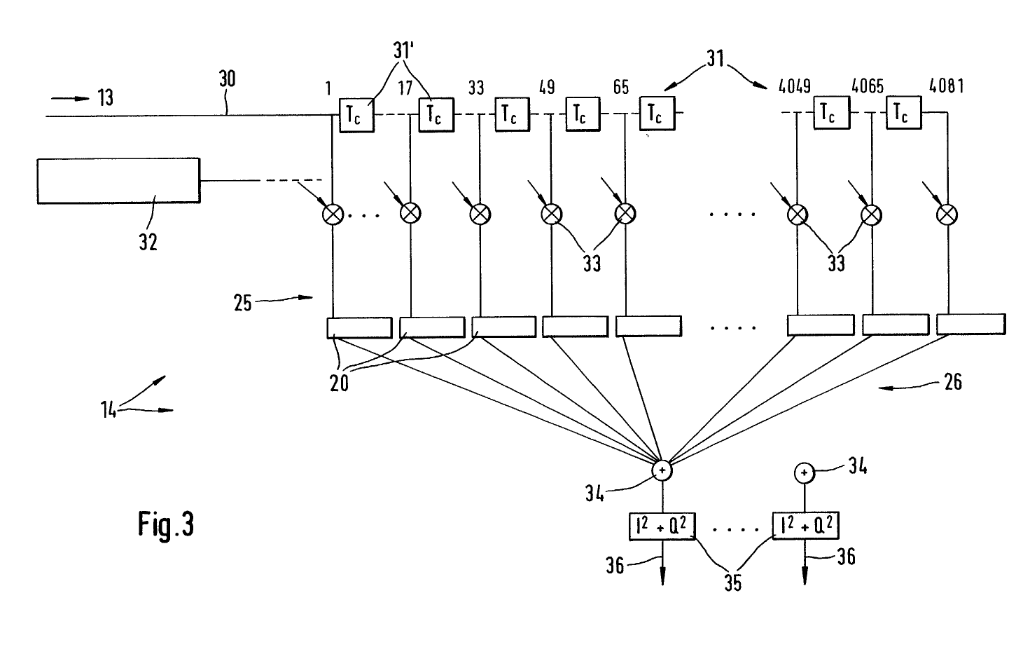

FIG. 3 is a representation of the detector 14 of the base station 12. As already stated, the detector 14 serves to recognize one or more of 16 possible signatures on the basis of the received signal 13. If a single signature is recognized by the detector, this means that a single mobile unit 11 is attempting to access the base station 12. If several signatures are recognized, several mobile units 11 are seeking to access the base station 12. Since there are 16 possible different signatures, a maximum of 16 mobile units 11 can simultaneously access the base station 12 as new users.

The signal 13 received by the base station 12 is supplied to the detector 14 via a line 30. The detector 14 comprises a shift register 31 which has a length of 4096 chips. Only some stages 31′ of the shift register 31 are shown in FIG. 3. Each of the stages 31′ of the shift register 31 causes the received signal 13 to be subjected to a time delay of a clock pulse unit T_{c}.

The scrambling code by means of which the signal 13 is generated by the mobile unit 11 is also known in the base station 12. This is indicated in FIG. 3 by the block 32. As already stated, this scrambling code has a length of 4096 chips.

The detector 14 includes a plurality of linkage operations 33 by means of which one chip of the signal 13 is in each case linked to one chip of the scrambling code. The scrambling function performed in the mobile unit 11 is reversed by means of the linkage operations 33. The linkage operations 33 are thus used to re-generate the data word that was present in the mobile unit 11 prior to the scrambling function. As already explained, this data word has a length of 4096 chips, these 4096 chips representing a 256-fold repetition of the 16-chip-long signature.

The detector 14 also comprises a total of 256 detector elements 20, as already described with reference to FIGS. 2a and 2b. The 4096 chips of the aforementioned data word are supplied to the inputs 25 of these detector elements 20. Sixteen chips of the said data word are supplied to each detector element 20, as also represented in FIG. 2b. With this design of the detector 14, the 256-fold repetition of the signature in the generation of the signal 13 within the mobile unit 11 is reversed or re-resolved.

As indicated schematically in FIG. 3, the outputs 26 of the detector elements 20 of the detector 14 which correspond respectively to one another are linked to one another by means of addition stages 34. Since there are 256 detector elements 20, 256 chips are in each case linked to one another at each addition stage 34.

As shown by FIG. 2b, each of the detector elements 20 has 16 outputs 26. Consequently, there are also only 16 addition stages 34. Arranged after each of the addition stages 34 is a block 35 by means of which the square value of the respectively present signal of the addition stage 34 is determined.

In this way, 16 outputs signals 36 of the blocks 35 are obtained which correspond to the 16 possible signatures. In the case of the recognized signature—as already explained—the associated output signal 36 is distinguished from the other output signals 36 of the blocks 35 by a different signal strength.

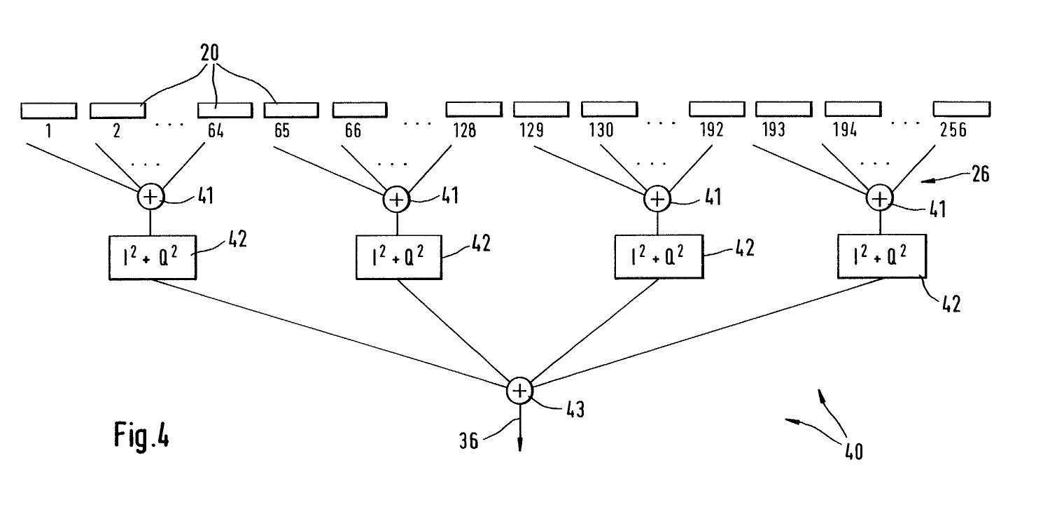

FIG. 4 shows a detector 40 which represents a modification of the detector 14 of FIG. 3. The same references are used to denote the same components and functions.

Like the detector 14, the detector 40 comprises a total of 256 detector elements 20 according to FIG. 2b. By contrast with the detector 14, the mutually assigned outputs 26 of the total of 256 detector elements 20 are not all supplied respectively to one of the addition stages 34. Rather, in the case of the detector 40, in each case, for example, 64 of the 256 mutually assigned outputs 26 of the detector elements 20 are linked to one another. It is to be understood that any other number of outputs 26, instead of 64 outputs 26, can be linked to one another. In the embodiment example of FIG. 4, the detector 40 comprises the addition stages 41, which are four times greater in number than the number of addition stages 34 of the detector 14.

Arranged respectively after each 4 mutually assigned addition stages 41 of the detector 40 are 4 blocks 42 which again serve to calculate the square value of the signal present. The now actually existing 4 output signals of the blocks 42 are then combined by means of further addition stages 43 so that the 16 output signals 36 which, as already explained, correspond to the 16 possible signatures, are then again present.

By comparison with the detector 14 of FIG. 3, the detector 40 of FIG. 4 achieves a better compensation of Doppler effects which can occur in the transmission of the signal 13 between the mobile unit 11 and the base station 12. Generally, any frequency offset between source and drain can be compensated by means of the modification of FIG. 4.

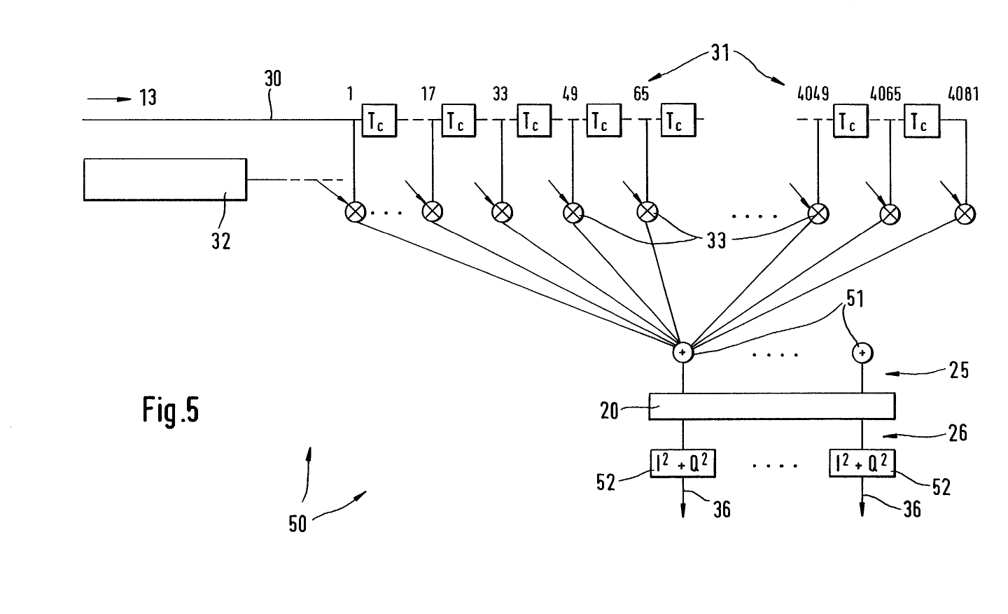

FIG. 5 shows a detector 50 which represents a simplification of the detector 14 of FIG. 3. The same references are used to denote the same components and functions.

Like the detector 14, the detector 50 comprises the line 30 for the signal 13 received by the base station 12, as well as the then subsequent shift register 31 for the 4096 chips of the signal 13. Like the detector 14, the detector 50 also comprises both the block 32 for the scrambling code and the linkage operations 33, so that the data word that was present in the mobile unit 11 prior to the explained scrambling function is again present at the outputs of the linkage operations 33. As already explained, this data word has a length of 4096 chips.

By contrast with the detector 14, in which the detector elements 20 are arranged after the linkage operations 33, in the case of the detector 50, a total of 16 addition stages 51, each with 256 inputs, are arranged after the 4096 linkage operations 33. In each case, these addition stages 51 link to one another those chips of the aforementioned data word which are separated from one another by an interval of 16 chips and which thus correspond to the same chip of the 16-chip-long signature. With this design of the detector 50, the repetition of the signature in the generation of the signal 13 is thus reversed or re-resolved.

The outputs of the 16 addition stages 51 are then supplied to the 16 inputs 25 of a single detector element 20 according to FIG. 2b. Arranged after each of the outputs 26 of the detector element 20 is a block 52 by means of which the square value of the respectively existing signal is determined.

In this way, there are again produced at the outputs of the blocks 52 the output signals 36 which, as already explained, correspond to the 16 possible signatures by which 16 different mobile units can be differentiated from one another.

By comparison with the detector 14 of FIG. 3, only a single detector element 20 according to FIG. 2b is required in the case of the detector 50 of FIG. 5.

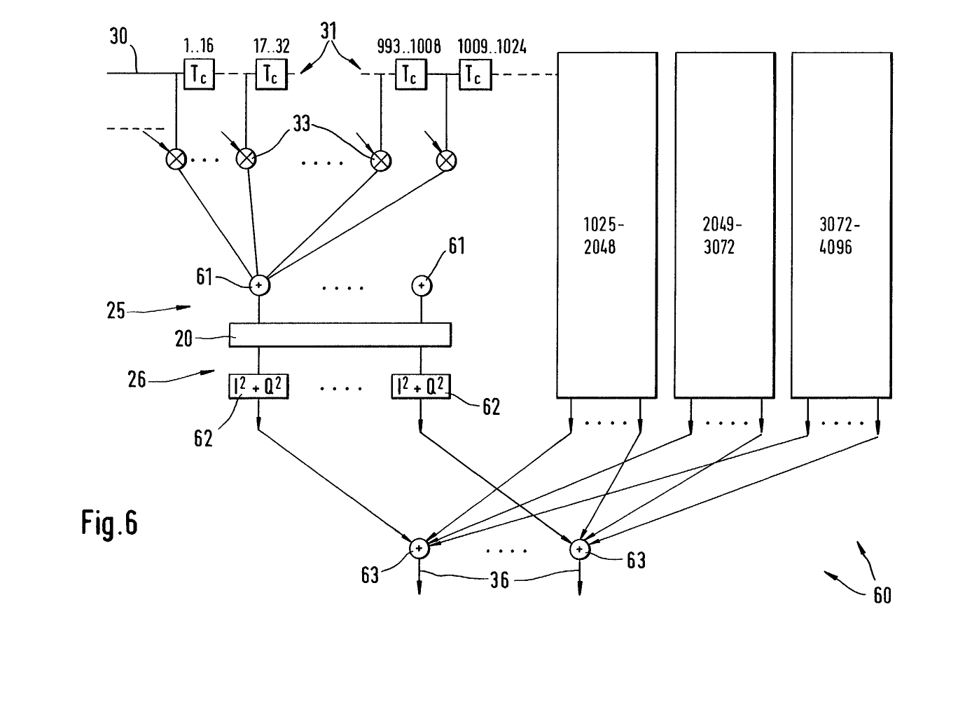

FIG. 6 shows a detector 60 which represents a simplification of the detector 14 of FIG. 3 and a modification of the detector 40 of FIG. 4. The same references are used to denote the same components and functions.

Like the detector 14, the detector 60 comprises the line 30 for the signal 13 received by the base station 12, as well as the then subsequent shift register 31 for the 4096 chips of the signal 13. Like the detector 14, the detector 60 also comprises the scrambling code and the linkage operations 33, so that the data word that was present in the mobile unit 11 prior to the explained scrambling function is again present at the outputs of the linkage operations 33. As already explained, this data word has a length of 4096 chips.

By contrast with the detector 14, in which the detector elements 20 are arranged after the linkage operations 33, in the case of the detector 60, a total of 4×16=64 addition stages 61 are arranged after the 4096 linkage operations 33. It is to be understood that, instead of the 64 addition stages 61, any other number between 1×16=16 and 256×16=4096 can also be selected. In FIG. 6, in each case the addition stages 61 link to one another those chips of the aforementioned data word which are separated from one another by an interval of 16 chips.

A further difference is that, in the case of the detector 60, not all 256 associated outputs of the linkage operations 33 are linked to one another, as in the case of the detector 50 of FIG. 5. Rather, in the case of the detector 60, in each case, for example, 64 of the 256 mutually assigned outputs are linked to one another. This design corresponds to the formation of blocks in the case of the detector 40 of FIG. 4. With this design of the detector 60, the repetition of the signature in the generation of the signal 13 is thus at least partially reversed before the detector elements 20.

The outputs of the 4×16=64 addition stages 61 are then supplied to the 16 inputs 25 of the total of 4 detector elements 20. Arranged respectively after each of the outputs 26 of the 4 detector elements 20 is a block 62 by means of which the square value of the respectively present signal is calculated. The now actually existing 4 output signals of the blocks 62 are then combined by means of further addition stages 63 so that the 16 output signals 36 which, as already explained, correspond to the 16 possible signatures, are then again present.

By comparison with the detector 14 of FIG. 3, only 4 detector elements 20 according to FIG. 2b are required in the case of the detector 60 of FIG. 6. Doppler effects, which can occur in the transmission of the signal 13 between the mobile unit 11 and the base station 12, are also better compensated than in the case of the detector 14 of FIG. 3.

1. Method for the operation of a radio-operated telecommunication system, in which a mobile unit generates and transmits a signal which is provided as an access request by the mobile unit to a base station, and in which the signal is received by the base station and the access request is recognized, wherein a Hadamard transform is used in the generation of the signal in the mobile unit and in the recognition of the signal in the base station.

2. Method according to claim 1, wherein in the generation of the signal by the mobile unit, a signature is generated on the basis of the Hadamard transform and multiply repeated, and the base station recognizes the signature from the received signal by means of the Hadamard transform.

3. Method according to claim 2, wherein the Hadamard transform is first applied by the base station to each of the repetitions of the signature and the signature is then deduced from the results of the applications of the Hadamard transform (FIG. 3).

4. Method according to claim 3, wherein the results of the applications of the Hadamard transform are combined in blocks and the signature is then deduced from the results of the blocks (FIG. 4).

5. Method according to claim 2, wherein the repetitions of the signature are first linked to one another by the base station and the signature is then deduced from the linkages by means of the Hadamard transform (FIG. 5).

6. Method according to claim 5, wherein the linkages of the repetitions are combined in blocks and the signature is then deduced from the results of the blocks (FIG. 6).

7. Method according to any one of the preceding claims, wherein a scrambling code is used by the mobile unit in the generation of the signal, and the same scrambling code is used by the base station in the processing of the signal.

8. Detector for a base station of a radio-operated telecommunication system, in which a mobile unit generates and transmits a signal which is provided as an access request by the mobile unit to the base station, and in which the signal is received by the base station and the access request is recognized, wherein said signal received by the base station is based on a Hadamard transform, and the detector is suitable for the application of the Hadamard transform.

9. Detector according to claim 8, wherein said signal received by the base station comprises a signature which is based on the Hadamard transform and which is multiply repeated, the detector comprises a plurality of detector elements which are assigned to the individual repetitions of the signature, and the associated output signals of the detector elements are linked to one another (FIG. 3).

10. Detector according to claim 8, wherein said signal received by the base station comprises a signature which is based on the Hadamard transform and which is multiply repeated, the detector comprises a plurality of detector elements which are assigned to the individual repetitions of the signature, the associated output signals of the detector elements are linked in blocks, and the output signals of the blocks are linked to one another (FIG. 4).

11. Detector according to claim 8, wherein said signal received by the base station comprises a signature which is based on the Hadamard transform and which is multiply repeated, the repetitions of the signature are linked to one another, and the detector comprises a detector element to which the output signals of the linkages are supplied (FIG. 5).

12. Detector according to claim 8, wherein said signal received by the base station comprises a signature which is based on the Hadamard transform and which is multiply repeated, the repetitions of the signature are linked to one another, the linkages of the repetitions are combined in blocks, and the detector comprises a number of detector elements, corresponding to the number of the blocks, to which the output signals of the linkages are supplied (FIG. 6).

13. Base station of a radio-operated telecommunication system, in which a mobile unit generates and transmits a signal which is provided as an access request by the mobile unit to the base station, and in which the signal is received by the base station and the access request is recognized, wherein said signal received by the base station is based on a Hadamard transform, said base station having a detector which is suitable for the application of the Hadamard transform.

14. Radio-operated telecommunication system, in which a mobile unit generates and transmits a signal which is provided as an access request by the mobile unit to a base station, and in which the signal is received by the base station and the access request is recognized, wherein said signal received by the base station is based on a Hadamard transform, and the base station having a detector which is suitable for the application of the Hadamard transform.
